(19) United States
(12) Patent Application Publication
(10) Pub. No.: US 2014/0101670 A1
(43) Pub. Date: Apr. 10, 2014

(54) COMPUTING SYSTEM INCLUDING MULTI-CORE PROCESSOR AND LOAD BALANCING METHOD THEREOF

(71) Applicant: SAMSUNG ELECTRONICS CO., LTD., Suwon-si (KR)

(72) Inventor: SUNG-IL BAE, Yongin-si (KR)

(73) Assignee: SAMSUNG ELECTRONICS CO., LTD., Suwon-si (KR)

(21) Appl. No.: 13/948,519

(22) Filed: Jul. 23, 2013

(30) Foreign Application Priority Data
Oct. 5, 2012 (KR) 10-2012-0110752

(51) Int. Cl. G06F 9/46

(52) U.S. Cl. CPC G06F 9/46
USPC 718/105

(57) ABSTRACT

A load balancing method of a computing system includes calculating a workload of at least one core of a plurality of cores of a multi-core processor that is entering an idle state, and selecting a core from among the plurality of cores to operate as a common core according to the calculated workload, wherein the common core operates while in the idle state.

### CROSS-REFERENCE TO RELATED APPLICATIONS

This application claims priority under 35 U.S.C. §119 to Korean Patent Application No. 10-2012-0110752, filed on Oct. 5, 2012, the disclosure of which is incorporated by reference herein in its entirety.

### TECHNICAL FIELD

Exemplary embodiments of the present invention relate to a computing system, and more particularly, to a computing system including a multi-core processor and a load balancing method thereof.

### DISCUSSION OF THE RELATED ART

A modern computing system may include a high-performance processor having a high clock frequency. As the complexity and size of an application driven by the processor increase, the processor may process a much larger amount of arithmetic operations at the same time. A multi-core processor including a plurality of cores may be designed to process a large amount of arithmetic operations. In a multi-core processor, a large amount of arithmetic operations may be distributed to internal cores of the multi-core processor. The load on one core may be lowered so that an overall processing speed increases.

As time elapses, the accumulated amount of tasks processed by internal cores in the multi-core processor may be different from one another. For example, when a specific core processes a relatively large amount of tasks (e.g., if a thread necessitating a heavy workload is focused on a specific core, or if a specific core operates during a relatively long amount of time compared with other cores), the accumulated workload of the specific core may be more than that of other cores. A difference between the accumulated workloads of the different cores may cause a disparity in the lifetimes of the cores. For example, the lifetime of a core processing a relatively large amount of tasks may become shorter than the average lifetime of the core, and the lifetime of a core processing a relatively small amount of tasks may become longer than the average lifetime of the core.

The disparity of internal core lifetimes, which may occur as the result of the lack of load balancing, may influence the overall lifetime of the multi-core processor.

### SUMMARY

According to an exemplary embodiment of the present invention, a load balancing method of a computing system which includes a multi-core processor having a plurality of cores includes calculating a workload of at least one of the cores entering a idle state, and determining a common core, operating at the idle state, from among the cores according to the calculation result.

In exemplary embodiments, calculating the workload includes measuring a time when the at least one core continues to operate as the common core, and determining a workload of the at least one core by comparing the measured time with a reference time.

In exemplary embodiments, determining a common core includes selecting the common core of the cores according to the calculation result, and mapping a common logical identification to a physical identification of the common core selected.

In exemplary embodiments, selecting the common core further includes selecting the plurality of cores sequentially as the common core.

In exemplary embodiments, calculating the workload includes calculating a workload of a thread executed by the at least one core before entering into the idle state, and updating the workload of the at least one core by referring to the calculated workload of thread.

In exemplary embodiments, calculating a workload includes storing the updated workload of the at least one core in a load table.

In exemplary embodiments, determining a common core includes comparing workloads of the cores, and selecting a core, having the smallest workload, from among the cores to be the common core according to the comparison result.

In exemplary embodiments, selecting a common core further includes mapping a common logical identification to a physical identification of the determined common core.

In exemplary embodiments, the common core is selected when the multi-core processor enters the idle state or after the multi-core processor enters the idle state.

According to an exemplary embodiment of the present invention, a computing system includes a multi-core processor including a plurality of cores, and a load controller configured to determine a common core, operating at an idle state, from among the cores by referring to a workload of at least one of the cores.

In exemplary embodiments, the load controller includes a load count unit configured to calculate the workload of the at least one core, and an identification mapping unit configured to map a common logical identification to a physical identification of the determined common core.

In exemplary embodiments, the load count unit measures an amount of time that the at least one core continues to operate as a common core, and calculates the workload of the at least one core by referring to the measured time.

In exemplary embodiments, the load count unit calculates the workload of the at least one core based on a workload of a thread executed by the at least one core.

In exemplary embodiments, the load controller compares workloads of the cores to select a core, having the smallest workload, from among the cores to be the common core.

In exemplary embodiments, the load controller further includes a load table configured to store the calculated workload of the at least one of the cores.

According to an exemplary embodiment of the present invention, a load balancing method of a computing system includes calculating a workload of at least one core of a plurality of cores of a multi-core processor that is entering an idle state, and selecting a core from among the plurality of cores to operate as a common core according to the calculated workload, wherein the common core operates while in the idle state.

According to an exemplary embodiment of the present invention, a computing system includes a multi-core processor including a plurality of cores, and a load controller configured to select a core from among the plurality of cores to operate as a common core according to a workload of at least one core of the plurality of cores, wherein the common core operates while in an idle state.

According to an exemplary embodiment of the present invention, a load balancing method of a computing system includes measuring a continuative amount of time that a common core from among a plurality of cores of a multi-core processor has operated as the common core, wherein a measuring start point of the continuative amount of time corresponds to a point of time at which the common core enters an idle state, a measuring end point of the continuative amount of time corresponds to a current point of time, and the common core operates while in the idle state, comparing the measured continuative amount of time to a reference time, wherein the reference time represents a common core operation time limit, and selecting a core from among the plurality of cores different from the common core to operate as a new common core upon determining that the measured continuative amount of time exceeds the reference time.

Utilizing the computing system and the load balancing method according to exemplary embodiments of the present invention, a common core operating in an idle state may be determined according to a workload of each core. In this case, since a load of the common core is distributed to each core in a balanced manner, it is possible to prevent a lifetime of a specific core from being shortened. As a result, a lifetime of a multi-core processor may be improved.

### BRIEF DESCRIPTION OF THE DRAWINGS

The above and other features of the present invention will become more apparent by describing in detail exemplary embodiments thereof with reference to the accompanying drawings, in which:

FIG. 1 is a block diagram illustrating a computing system, according to an exemplary embodiment of the present invention.

FIG. 2 is a block diagram illustrating a load controller, according to an exemplary embodiment of the present invention.

FIG. 3 is a flowchart illustrating a load balancing method, according to an exemplary embodiment of the present invention.

FIG. 4 is a diagram showing an operation of a load controller performing a load balancing method, according to an exemplary embodiment of the present invention.

FIG. 5 is a flowchart illustrating a load balancing method, according to an exemplary embodiment of the present invention.

FIG. 6 is a diagram showing an operation of a load controller performing a load balancing method, according to an exemplary embodiment of the present invention.

FIG. 7 is a flowchart illustrating a load balancing method, according to an exemplary embodiment of the present invention.

FIG. 8 is a diagram illustrating a load table of a load controller that performs a load balancing method, according to an exemplary embodiment of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to like elements throughout the accompanying drawings.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “under”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

As used herein, the singular forms “a”, “an” and “the” are intended to include the plural forms as well, unless the context clearly indicates otherwise.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present.

Herein, an idle state may refer to a state in which a multi-core processor (or a core of a multi-core processor) is not currently processing a task (e.g., a task requested by a program), even though the multi-core processor (or a core of the multi-core processor) is in an operable state and is capable of processing a task. Alternatively, an idle state may refer to a state in which a multi-core processor (or a core of a multi-core processor) is waiting for a command for initiating a task.

Herein, a common core may refer to a core from among a plurality of cores in a multi-core processor that operates in the idle state. The common core may be a core that first operates when at least one core of the plurality of cores in the multi-core processor operates. For example, when one of the cores in the multi-core processor operates, the common core of the cores in the multi-core processor may operate. Alternatively, when two cores in the multi-core processor operate, the common core and another core in the multi-core processor may operate. Similarly, when three cores in the multi-core processor operate, the common core and two other cores in the multi-core processor may operate. Thus, a common core may refer to a core from among the plurality of cores in a multi-core processor that is active during an idle state, even though the core is not currently processing any tasks while active in the idle state.

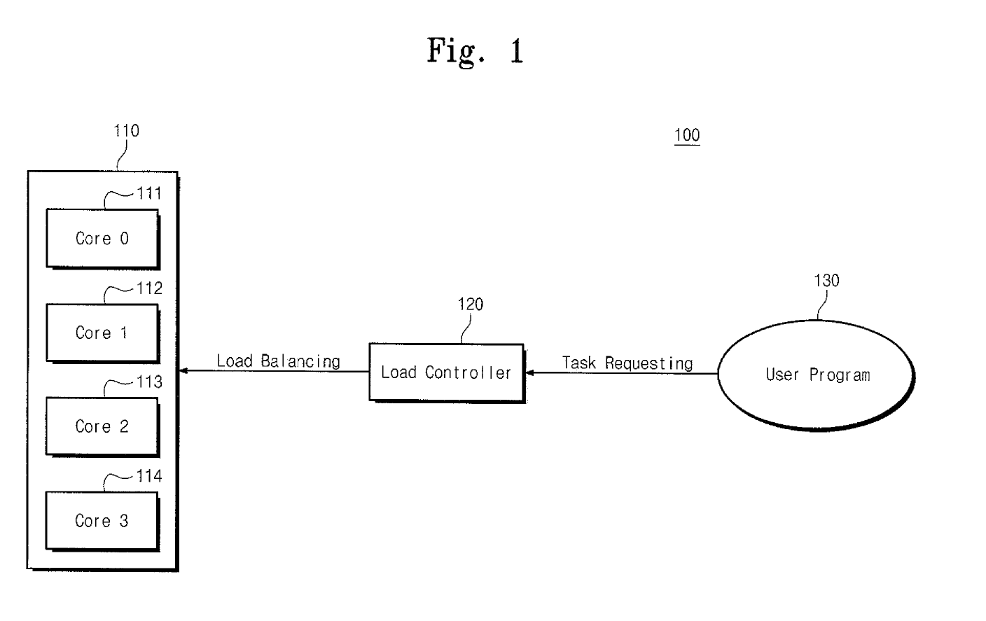

FIG. 1 is a block diagram illustrating a computing system, according to an exemplary embodiment of the present invention. Referring to FIG. 1, a computing system 100 may include a multi-core processor 110, a load controller 120, and a user program 130.

The multi-core processor 110 may include a plurality of cores 111, 112, 113, and 114. The multi-core processor 110 may process a task requested by the user program 130. The cores 111, 112, 113, and 114 in the multi-core processor 110 may operate independently. For example, different threads to be processed may be assigned to the cores 111, 112, 113, and 114, respectively. Although FIG. 1 shows the multi-core processor 110 includes four cores, the multi-core processor 110 is not limited thereto. For example, the multi-core processor 110 may include three or less cores or five or more cores.

The user program 130 may include software utilized to process a specific task, and may request a task to be performed at the multi-core processor 110. In exemplary embodiments, the user program 130 may be, for example, an operating system (OS) or an application program. In exemplary embodiments, the user program 130 may be stored in a hard disk drive, and may be loaded on a memory (e.g., a DRAM) during an operation, however, the user program 130 is not limited thereto. The user program 130 may provide a thread as a processing unit for a requested task.

The load controller 120 may distribute a load to the respective cores 111 to 114 of the multi-core processor 110 in response to a task request received from the user program 130. The load controller 120 may distribute a load to the respective cores 111 to 114 of the multi-core processor 110 in a balanced fashion by referring to a workload of each of the cores 111 to 114 (e.g., load balancing).

In exemplary embodiments, the load controller 120 may select one of the cores 111 to 114 to be a common core by referring to a workload of each of the cores 111 to 114. For example, the load controller 120 may select the core having the smallest workload from among the cores 111 to 114 to operate as the common core. Alternatively, if a specific core operates as the common core for a predetermined amount of time, another core may be selected to be used as the common core by the load controller 120.

Since the load of the common core may be large, the load controller 120 may change the core to be used as the common core by referring to a workload of each of the cores 111 to 114.

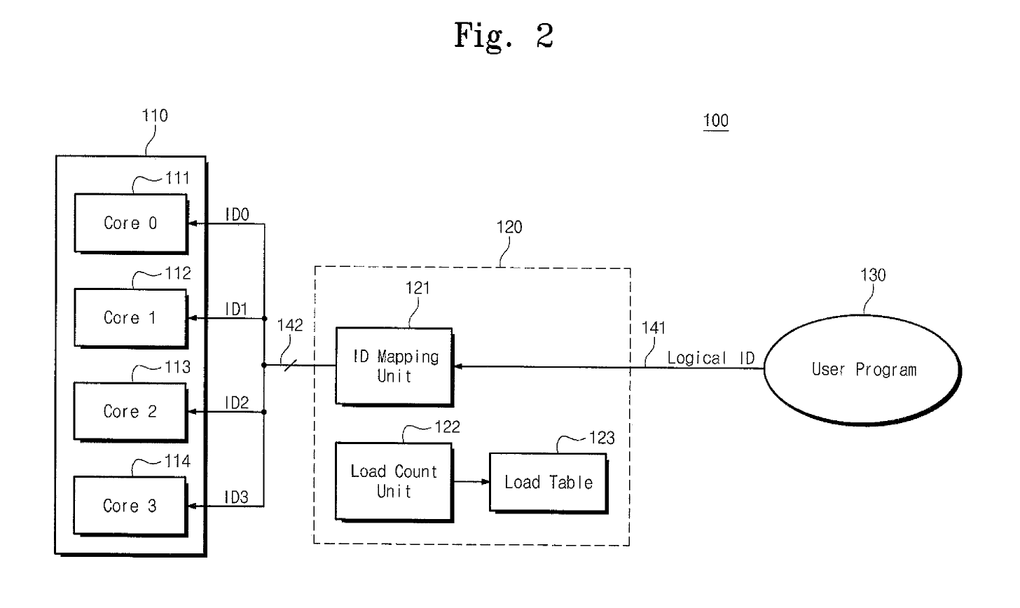

A method in which the load controller 120 performs load balancing on the cores 111 to 114 according to an exemplary embodiment of the present invention will be further described with reference to FIG. 2.

The computing system 100 may select the common core operating in an idle state by referring to a workload of each core. In this case, a load of the common core may be distributed to each core in a balanced manner, which may prevent the lifetime of a specific core from being shortened (e.g., by having a higher accumulated workload relative to the other cores). As a result, the lifetime of the multi-core processor 110 may be improved.

FIG. 2 is a block diagram illustrating a load controller, according to an exemplary embodiment of the present invention. Referring to FIG. 2, a load controller 120 may include an identification mapping unit 121, a load count unit 122, and a load table 123.

The load controller 120 may distribute the load of a task requested to be performed by a user program 130 to cores 111 to 114 of a multi-core processor 110. For example, the load controller 120 may map logical identification provided from the user program 130 to one of physical identifications 142 of the cores 111 to 114. In exemplary embodiments, the load controller 120 may map logical identifications to physical identifications 142 of the cores 111 to 114, respectively. A load (e.g., a thread) provided via a logical identification may be assigned to a core having a physical identification corresponding to the logical identification.

For example, it is assumed that the logical identification 141 is mapped to a physical identification ID0 of a first core 111 through the load controller 120. In this case, the first core 111 may process a load (e.g., a thread) provided through the logical identification 141 from the user program 130. If the logical identification 141 is newly mapped to a second core 112 through the load controller 120, a load provided through the logical identification 141 may later be processed by the second core 112.

In exemplary embodiments, the load controller 120 may map a provided logical identification 141 selectively to physical identifications 142 of the cores 111 to 114 by referring to the workload of each core. For example, when the logical identification 141 provides a load (e.g., a thread), the load controller 120 may map the logical identification 141 to a physical identification corresponding to a core from among the cores 111 to 114 that has the smallest workload.

In exemplary embodiments, the load controller 120 may map a logical identification 141 providing a thread necessitating a heavy workload to the physical identification of the core from among the cores 111 to 114 that has the smallest workload.

In exemplary embodiments, the load controller 120 may map a logical identification requiring a long time of operation to a physical identification of the core from among the cores 111 to 114 that has the smallest workload.

In exemplary embodiments, the load controller 120 may map a logical identification directing an operation as a common core to a physical identification of the core from among the cores 111 to 114 that has the smallest workload.

The identification mapping unit 121 may selectively map the logical identification 141 provided from the user program 130 (or from another source external to the load controller 120) to the physical identifications 142 of the cores 111 to 114.

The load count unit 122 may count the workload of each of the cores 111 to 114. The workloads counted by the load count unit 122 may be expressed, for example, by the size of data of the workloads of each of the cores 111 to 114, by the number of arithmetic operations processed by each of the core 111 to 114, or by the working time of each of the cores 111 to 114.

For example, the load count unit 122 may count the working time of the first core 111 as the workload of the first core 111. Alternatively, the load count unit 122 may count the size of data or the number of arithmetic operations processed by the first core 111 as the workload of the first core 111.

The load table 123 may store the workload of each of the cores 111 to 114 counted by the load count unit 122. The load table 123 may be referred to by the load controller 120 when determining load balancing for the cores 111 to 114. For example, the load controller 120 may map a logical identification provided from the user program 130 to a physical identification of the core having the smallest workload by referring to the load table 123. Thus, the load controller 120 may map the logical identification 141 to the physical identifications 142 based on the load table 123 and the load count unit 122.

In exemplary embodiments, the load controller 120 may map a common logical identification to a physical identification corresponding to the core from among the cores 111 to 114 that has the smallest workload by referring to the load table 123.

In exemplary embodiments, when the respective workloads of the cores 111 to 114 has been newly counted, the load table 123 may be updated according to the newly counted workloads.

The load controller 120 may selectively map the logical identification 141 to physical identifications 142 of the cores 111 to 114 based on a workload of a core. That is, the load controller 120 may perform load balancing by first distributing a load to a core having the smallest workload. As a result, the overall lifetime of the multi-core processor 110 may be improved.

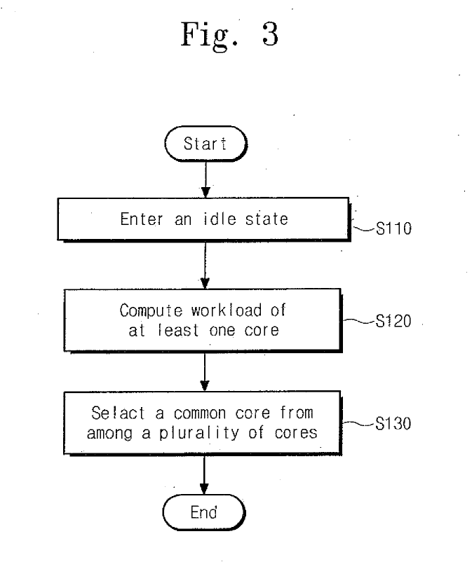

A computing system and a load balancing method according to exemplary embodiments of the present invention will be described with reference to FIG. 3. In exemplary embodiments, an example is described in which a load balancing operation is performed when a multi-core processor enters an idle state. However, exemplary embodiments of the present invention are not limited thereto. For example, the load balancing operation can be performed when a multi-core processor is not in an idle state. In this case, at least two cores (e.g., a common core and a core that is to be selected as a common core) are in an idle state, and the common core is re-determined and selected again.

FIG. 3 is a flowchart illustrating a load balancing method, according to an exemplary embodiment of the present invention.

At operation S110, cores 111 to 114 in the multi-core processor 110 (refer to FIG. 1) may enter an idle state. Herein, as described above, the idle state may refer to a state in which although a core is in an operable state, the core is not currently processing a task requested by a program (e.g., the user program 130). That is, the idle state may indicate a state before a new task is performed after the processing of an assigned task (e.g., a thread). For example, the idle state may correspond to period of time between a core processing a previous task and the processing a subsequent task. A core (e.g., a common core) having a high priority may operate.

At operation S120, the computing system 100 (refer to FIG. 1) may compute a workload of at least one of the cores 111 to 114. In exemplary embodiments, the computed workload of a core may be a working time of the core. Alternatively, the computed workload of the core may be an accumulated workload (e.g., an accumulated data amount or an accumulated computing amount) of a load (e.g., a thread) processed by the core.

At operation S130, the computing system 100 may select one of the cores 111 to 114 as a common core according to the computed workload of the cores. In exemplary embodiments, the computing system 100 may select the core having the smallest workload to be the common core. Alternatively, the computing system 100 may select a core having a short working time as the common core. Alternatively, the computing system 100 may select a core, which is not selected as the common core after entering the idle state, to be the common core.

The computing system 100 may map a logical identification (e.g., a common logical identification) directing an operation as a common core to a physical identification of the selected common core.

According to the above description, a common core operating in an idle state may be determined according to a workload of a core. Load balancing may be achieved by setting a core having a smaller workload than other cores as a common core, rather than setting a core having a heavy workload as the common core. As a result, the lifetime of a multi-core processor may be improved.

According to exemplary embodiments of the present invention, a workload of at least one core of the plurality of cores 111 to 114 of the multi-core processor 110 that is entering an idle state is calculated. A core from among the plurality of cores 111 to 114 is then selected to operate as a common core according to the calculated workload.

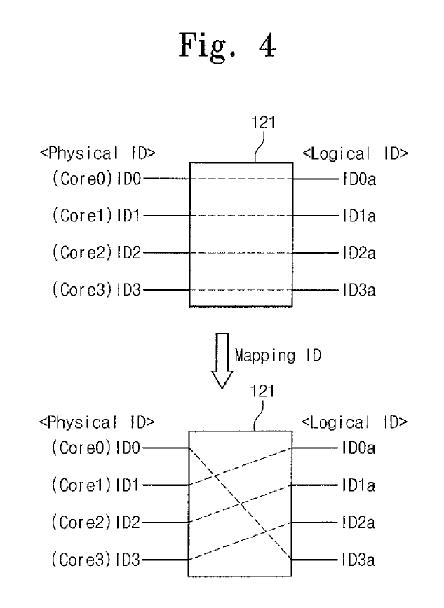

FIG. 4 is a diagram showing an operation of a load controller performing a load balancing method, according to an exemplary embodiment of the present invention. Referring to FIG. 4, an identification mapping unit 121 may map a plurality of logical identifications ID0a, ID1a, ID2a, and ID3a to a plurality of physical identifications ID0, ID1, ID2, and ID3.

In FIG. 4, an example is shown in which mapping between a plurality of logical identifications and a plurality of physical identifications is performed by the identification mapping unit 121. However, exemplary embodiments of the present invention are not limited thereto. For example, the identification mapping unit 121 may map a logical identification selectively to one of a plurality of physical identifications.

The upper portion of FIG. 4 indicates the first correspondence in which mapping between logical identifications and physical identifications is performed by an identification mapping unit 121. At an initial stage, the identification mapping unit 121 may map the logical identifications ID0a, ID1a, ID2a, and ID3a to the physical identifications ID0, ID1, ID2, and 1D3, respectively. A task (e.g., a thread, load, etc.) provided through a logical identification may be processed by a core having a physical identification corresponding to the logical identification. For example, a task provided through a first logical identification ID0a may be processed by a first core 111 having a physical identification ID0 corresponding to the logical identification ID0a. At this time, if the logical identification ID0a is a common logical identification, a core Core0 having a physical identification ID0 corresponding to the logical identification ID0a may become a common core.

The identification mapping unit 121 may change correspondence between logical identifications and physical identifications in response to the load controller 120 (refer to FIG. 2) (e.g., the identification mapping unit 121 may be controlled by the load controller 120). At this time, the load controller 120 may control the identification mapping unit 121 such that each of the logical identifications ID0a, ID1a, ID2a, and ID3a is mapped to one of the physical identifications ID0, ID1, ID2, and ID3 according to the respective workloads of each of cores Core0, Corel, Corel, and Core3. In this case, the load controller 120 may refer to the load table 123 (refer to FIG. 2) in which the workloads of the cores are stored.

The bottom portion of FIG. 4 shows that the identification mapping unit 121 may change the correspondence between logical identifications and physical identifications in response to the load controller 120 (e.g., the identification mapping unit 121 may be controlled by the load controller 120). The load controller 120 may control the identification mapping unit 121 such that a common core is changed according to the workloads of the cores Core0, Core1, Core2, and Core3.

For example, in a case in which the second core Core1 has the smallest workload, the identification mapping unit 121 may map a common logical identification ID0a to a physical identification ID1 of the second core Core1. At this time, a common core may be changed from the first core Core0 to the second core Core1. Meanwhile, the remaining logical identifications ID1a, ID2a, and ID3a may correspond to the remaining physical identifications ID0, ID2, and ID3.

Other operations of the identification mapping unit 121 and the load controller 120 may be substantially the same as described above.

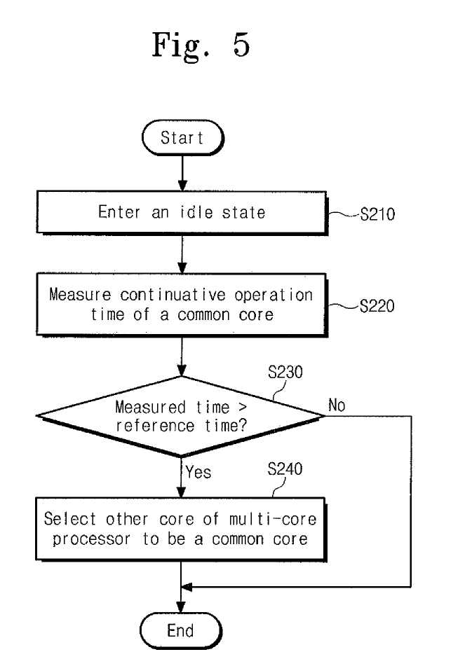

FIG. 5 is a flowchart illustrating a load balancing method, according to an exemplary embodiment of the present invention. In exemplary embodiments, operations S220 and S230 may be performed to compute a workload of a core.

In operation S210, cores 111 to 114 (refer to FIG. 1) of the multi-core processor 110 (refer to FIG. 1) may enter an idle state. Herein, the meaning of the idle state may be the same as described with reference to FIG. 3.

In operation S220, the computing system 100 may measure a continuative operation time of a common core. For example, when the first core 111 (refer to FIG. 2) is a common core, the computing system 100 may continue to measure the time that the first core 111 operates as a common core after entering into the idle state. In the event that the first core 111 is the common core from a point of time when the first core 111 enters the idle state, a measuring start point of time may be a point of time corresponding to when the first core enters the idle state, and a measuring end point of time may be a current point of time. In the event that the first core 111 is selected as the common core instead of another core from a point of time when the first core 111 enters the idle state, a measuring start point of time may be a point of time when the first core operates as the common core, and a measuring end point of time may be a current point of time.

In exemplary embodiments, the amount of time that any core continues to operate as a common core (e.g., the continuative operation time) may be measured by the load count unit 122 (refer to FIG. 2).

At operation S230, the computing system 100 may compare the measured time with a reference time. Herein, the reference time may be a predetermined time representing a desired time limit for which any core is to operate as a common core (e.g., a common core operation time limit). The computing system 100 may compare the measured continuative operation time with the reference time, and when the measured continuative time exceeds the reference time, the common core may be changed.

In exemplary embodiments, the comparison result between the measured continuative operation time and the reference time may be stored as a workload of a common core. For example, if the measured continuative operation time exceeds the reference time, a workload of a common core having a ‘1’ value may be stored under control of the computing system 100. If the measured continuative operation time does not exceed the reference time, a workload of a common core having a ‘0’ value may be stored under control of the computing system 100. A workload of a common core may be stored in the load table 123 (refer to FIG. 2) or in a separate register.

If the measured continuative operation time exceeds the reference time, the method proceeds to operation S240. If the measured continuative operation time does not exceed the reference time, the method may be ended.

At operation S240, the computing system 100 may select a core from among cores 111 to 114 that is not currently the common core to be a new common core. If the measured continuative operation time exceeds the reference time (e.g., if a workload of the common core is ‘1’), the computing system 100 may implement a process to change the common core by referring to a workload of the common core. The computing system 100 may select a core from among the cores 111 to 114 that is not currently the common core to be a new common core, and may map a common logical identification to a physical identification of the selected core.

For example, if the first core 111 is a common core, the computing system 100 may select a core (e.g., the second core 112) from among the second to fourth cores 112 to 114 as a new common core, and may map a common logical identification to a physical identification of the second core 112. After this process, the second core 112 may operate as a common core.

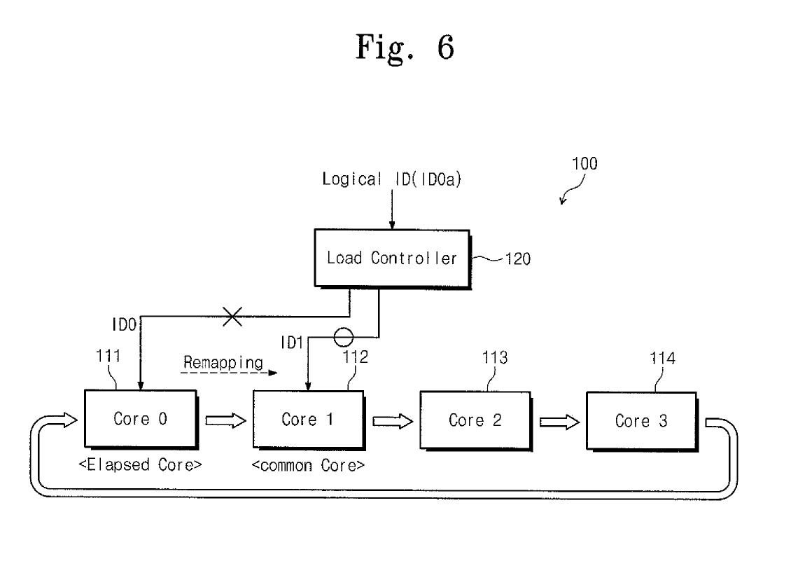

An operation in which the computing system 100 selects a core from among the cores 111 to 114 that is not currently a common core to be a new common core will be further described with reference to FIG. 6.

If any core operates as a common core over a predetermined period of time, a new core may be selected as a new common core. As a result, a core may be prevented from being worn out by limiting an amount of time that the core operates as a common core. That is, the lifetime of the core may be prevented from being shortened, and as a result, the lifetime of the multi-core processor 110 may be improved.

FIG. 6 is a diagram showing an operation of a load controller performing a load balancing method, according to an exemplary embodiment of the present invention. Referring to FIG. 6, a load controller 120 may map a common logical identification ID0a to one of cores 111 to 114.

If the amount of time that any core operates as a common core exceeds the reference time, the computing system 100 may change the common core to another core to prevent excessive wear of a core.

In exemplary embodiments, a change of a common core may be performed by a load controller 120.

A change of a common core may be performed by selecting one core from among the plurality of cores that is not currently a common core to be the common core, and setting the selected core as the common core (e.g., random switching).

Alternatively, a change of a common core may be performed by selecting one core from among the plurality of cores to be the common core sequentially according to an order of physical identifications of the cores (e.g., sequential switching).

In FIG. 6, an example of sequential switching is shown.

In FIG. 6, it is assumed that a first core 111 is a common core. It is further assumed that a workload of the first core 111 is ‘1’ (e.g., the measured continuative time exceeds a reference time, as described above).

Since a time that the first core 111 has operated as a common core exceeds the reference time, the computing system 100 may select another core to be the common core instead of the first core 111, to prevent wear of the first core 111.

In exemplary embodiments, the changing of the common core may be performed by the load controller 120.

When sequential switching is utilized, cores may be selected to be the common core sequentially according to an order of physical identification numbers of the cores (e.g., ID0→ID1→ID2→ID3→ID0).

For example, if the amount of time that the first core 111 has operated as the common core exceeds the reference time (e.g., if a workload of the first core 111 is ‘1’), the load controller 120 may select a second core 112 to be the new common core. The load controller 120 may remap a common logical identification to the physical identification ID1 of the second core 112 instead of the physical identification ID0 of the first core 111. In this case, the second core 112 may operate as the common core.

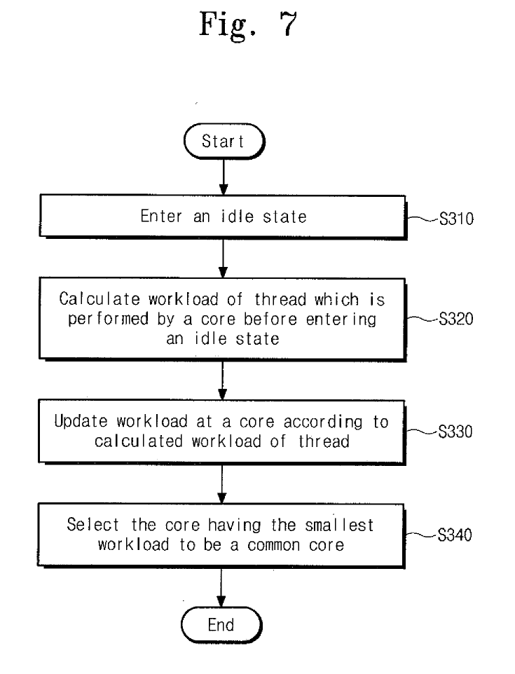

FIG. 7 is a flowchart illustrating a load balancing method, according to an exemplary embodiment of the present invention. In exemplary embodiments, operations S320 and S330 may be performed to compute a workload of a core.

At operation S310, cores 111 to 114 (refer to FIG. 1) of the multi-core processor 110 (refer to FIG. 1) may enter an idle state. Herein, the meaning of the idle state may be the same as described with reference to FIG. 3.

At operation S320, the computing system 100 (refer to FIG. 2) may calculate a thread workload of at least one of cores 111 to 114 executed before entering an idle state. Herein, the calculated workload may be a data amount of the thread or the number of arithmetic operations performed by each of the cores 111 to 114 to process a thread.

In exemplary embodiments, a thread workload of a core may be calculated by the load count unit 122.

At operation S330, the computing system 100 may update a workload of a core according to the calculated workload of the thread. For example, the computing system 100 may update the workload of the core cumulatively by adding the calculated workload of the thread to a previous workload of the core.

For example, if a previous workload of a core is ‘1000’ and a calculated thread workload is ‘100’, a workload of the core may be updated to be set to 1100 (e.g., 1000+100).

In exemplary embodiments, operation S330 may include storing the calculated workload of the thread or the updated workload of the core at the load table 123 (refer to FIG. 2).

At operation S340, the computing system 100 may select the core that has the smallest workload to be the common core by referring to the workloads of the cores 111 to 114.

In exemplary embodiments, operation S340 may be divided into a first operation that includes comparing workloads of the cores 111 to 114, and a second operation that includes selecting the core from among the cores 111 to 114 that has the smallest workload to be the common core according to a comparison result.

For example, the computing system 100 may compare the workloads of the cores 111 to 114. At this time, the computing system 100 may refer to the load table 123 for comparison of the workloads. A core having the smallest workload may be selected to be the common core according to a comparison result. The computing system 100 may map a common logical identification (e.g., ID0a) (refer to FIG. 4) to a physical identification of the core selected as the common core. Thus, a core having the smallest workload may operate as the common core.

In exemplary embodiments, the common core may be selected at the same time as entering an idle state, or at a time subsequent to entering the idle state (e.g., a time shortly after entering an idle state). Further, the common core may be selected iteratively when cores 111 to 114 enter the idle state.

As described above, the common core operating at the idle state may be selected according to a workload of a core. Load balancing between cores may be performed by selecting a core having the smallest workload to be the common core. As a result, the cores may be prevented from being worn out quickly, and thus, the lifetime of the multi-core processor 110 may be improved.

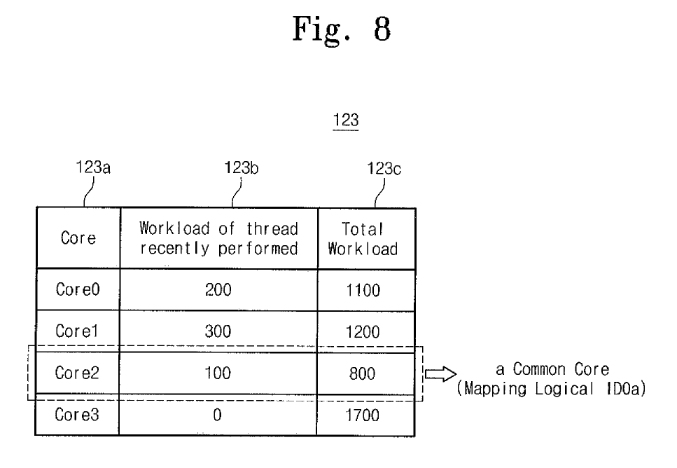

FIG. 8 is a diagram illustrating a load table of a load controller that performs a load balancing method, according to an exemplary embodiment of the present invention. Referring to FIG. 8, the load table 123 may include a core field 123a, a workload of the thread recently performed field 123b, and a total workload field 123c.

The core field 123a may be a field in which cores in a multi-core processor 110 are assigned. Although FIG. 8 shows an example in which four cores are assigned to the core field 123a, exemplary embodiments of the present invention are not limited thereto. For example, three or less cores or five or more cores may be assigned to the core field 123a according to the number of cores in the multi-core processor 110.

The workload of the thread recently performed field 123b may store the workload of a thread recently performed by cores assigned to the core field 123a. Herein, the meaning of the thread workload may be substantially the same as described above.

The total workload field 123c may store workloads of cores assigned to the core field 123a. The total workload field 123c may be updated cumulatively when a new thread workload is calculated. For example, if a workload of a third core Core2 is ‘700’ and a workload of a new thread is ‘100’, a workload of the third core Core2 may be updated to be set to 800 (e.g., 700+100).

As described above, the computing system 100 may select a core having the smallest workload as the common core by referring to the load table 123. For example, referring to the total workload field 123c, the third core Core2 may have the smallest workload of 800. Thus, the computing system 100 may select the third core Core2 to be the common core, and may map a common logical identification (e.g., ID0a) (refer to FIG. 4) to a physical identification of the third core Core2.

While the present invention has been particularly shown and described with reference to exemplary embodiments thereof, it will be understood by those skilled in the art that various changes in form and detail may be made therein without departing from the spirit and scope of the present invention as defined by the following claims.

What is claimed is:

1. A load balancing method of a computing system, comprising:
calculating a workload of at least one core of a plurality of cores of a multi-core processor that is entering an idle state; and
selecting a core from among the plurality of cores to operate as a common core according to the calculated workload,
wherein the common core operates while in the idle state.

2. The load balancing method of claim 1, wherein calculating the workload comprises:
measuring a continuative amount of time that the at least one core has operated as the common core; and
determining the workload of the at least one core by comparing the measured continuative amount of time with a reference time.

3. The load balancing method of claim 2, wherein selecting the core to operate as the common core comprises:
mapping a common logical identification to a physical identification corresponding to the selected common core.

4. The load balancing method of claim 1, wherein selecting the core to operate as the common core further comprises:
selecting, sequentially, each core from among the plurality of cores to operate as the common core.

5. The load balancing method of claim 1, wherein calculating the workload of the at least one core comprises:
calculating a workload of a thread executed by the at least one core before the at least one core enters the idle state; and
updating the workload of the at least one core according to the calculated workload of the executed thread.

6. The load balancing method of claim 5, wherein calculating the workload of the at least one core further comprises:
storing the updated workload of the at least one core in a load table.

7. The load balancing method of claim 5, wherein selecting the core to operate as the common core comprises:
comparing workloads of the plurality of cores with each other; and
selecting a core from among the plurality of cores having the smallest workload to operate as the common core.

8. The load balancing method of claim 7, wherein selecting the core to operate as the common core further comprises:
mapping a common logical identification to a physical identification corresponding to the selected common core.

9. The load balancing method of claim 1, wherein the common core is selected upon the multi-core processor entering the idle state or subsequent to the multi-core processor entering the idle state.

10. The load balancing method of claim 1, wherein the idle state corresponds to a period during which the multi-core processor is capable of processing a task and is not currently processing the task.

11. A computing system, comprising:
a multi-core processor comprising a plurality of cores; and
a load controller configured to select a core from among the plurality of cores to operate as a common core according to a workload of at least one core of the plurality of cores,
wherein the common core operates while in an idle state.

12. The computing system of claim 11, wherein the load controller comprises:
a load count unit configured to calculate the workload of the at least one core; and
an identification mapping unit configured to map a common logical identification to a physical identification corresponding to the selected common core.

13. The computing system of claim 12, wherein the load count unit is configured to measure a continuative amount of time that the at least one core has operated as the common core, and calculate the workload of the at least one core according to the measured continuative amount of time.

14. The computing system of claim 13, wherein the load count unit is configured to calculate the workload of the at least one core based on a workload of a thread executed by the at least one core.

15. The computing system of claim 14, wherein the load controller is configured to compare workloads of the plurality of cores with each other, select a core from among the plurality of cores having the smallest workload to operate as the common core.

16. The computing system of claim 12, wherein the load controller further comprises:
a load table configured to store the calculated workload of the at least one core.

17. The computing system of claim 11, wherein the idle state corresponds to a period during which the multi-core processor is capable of processing a task and is not currently processing the task.

18. A load balancing method of a computing system, comprising:
measuring a continuative amount of time that a common core from among a plurality of cores of a multi-core processor has operated as the common core, wherein a measuring start point of the continuative amount of time corresponds to a point of time at which the common core enters an idle state, a measuring end point of the continuative amount of time corresponds to a current point of time, and the common core operates while in the idle state;
comparing the measured continuative amount of time to a reference time, wherein the reference time represents a common core operation time limit; and
selecting a core from among the plurality of cores different from the common core to operate as a new common core upon determining that the measured continuative amount of time exceeds the reference time.

19. The load balancing method of claim 18, wherein selecting the new common core comprises:
mapping a common logical identification to a physical identification corresponding to the new selected common core.

20. The load balancing method of claim 18, wherein the idle state corresponds to a period during which the common core is capable of processing a task and is not currently processing the task.
